(19) United States
(12) Patent Application Publication
(10) Pub. No.: US 2020/0283606 A1
(43) Pub. Date: Sep. 10, 2020

(54) CABLE COMPRISING AN EASILY PEELABLE SEMI-CONDUCTIVE LAYER

(71) Applicant: NEXANS, Courbevoie (FR)

(72) Inventors: Christian KOELBLIN, MEXIMIEUX (FR); Melek MAUGIN, Chassagny (FR)

(21) Appl. No.: 16/722,712

(22) Filed: Dec. 20, 2019

(30) Foreign Application Priority Data
Dec. 21, 2018 (FR) 18 73986

(51) Int. Cl. C08L 23/08; H01B 3/44

(52) U.S. Cl. CPC C08L 23/0815; H01B 3/441

(57) ABSTRACT

An electrical cable has a cross-linked semi-conductive layer obtained from a cross-linkable polymer composition based on at least one non-polar olefin polymer, and at least 15% by weight of a butene polymer, with respect to the total weight of the cross-linkable polymer composition.

### RELATED APPLICATION

This application claims the benefit of priority from French Patent Application No. FR 18 73986, filed on Dec. 21, 2018, the entirety of which is incorporated by reference.

### BACKGROUND

### Field of the Invention

The invention relates to an electrical cable comprising a cross-linked semi-conductive layer obtained from a cross-linkable polymer composition based on at least one non-polar olefin polymer and at least 15% by weight of a butene polymer, with respect to the total weight of the cross-linkable polymer composition.

It is typically, but not exclusively applicable to the fields of medium voltage power cables (in particular from 6 to 45-60 kV) or to high voltage power cables (in particular above 60 kV, and may be up to 800 kV), irrespective of whether they are for direct current or alternating current applications.

More particularly, it is applicable to power cables having an easily peelable semi-conductive layer.

### Description of Related Art

A cable may be provided with a peelable semi-conductive layer. The peelability of a semi-conductive layer in particular means that zones of a cable where joints have to be inserted and/or where cable terminals have to be added in order to connect the cable to a device such as a power transformer, connection equipment, a bus bar system or an overhead line, can be prepared easily.

Semi-conductive layer compositions which are the most widely used comprise at least one polar ethylene copolymer of the copolymer of ethylene and vinyl acetate type. In particular, US 2006/182961 A1 describes a cross-linkable composition for a semi-conductive layer of an electrical cable comprising a copolymer of ethylene and vinyl acetate (EVA) and a propylene homopolymer. However, that solution is not satisfactory for the following reasons. On the one hand, during cross-linking of the semi-conductive layer in a continuous vulcanization line (widely known as a “CV line”), the EVA copolymer is degraded by the high temperatures employed and gives rise to residues such as acetic acid which accumulate in the tube and corrode it. In fact, in particular beyond approximately 200° C., cleavage of the vinyl acetate groups of the EVA copolymers may take place, with these groups then forming acetic acid in the presence of moisture. Furthermore, after cross-linking, polar by-products originating from the degradation of the EVA, including the acetic acid mentioned above, may remain present in the electrically insulating layer adjacent to the semi-conductive layer intended to be peeled. This causes an increase in the value for the dielectric loss factor (also known by the name of “tangent delta (tan δ)”), which may become a critical factor for cables operated at high voltages. Thus, using semi-conductive layers of the prior art which are intended to be peeled in high or very high alternating voltage cables is still exceptional, even though they are of great technological and economic interest. Furthermore, the compositions for semi-conductive layers intended to be peeled which are the most widely used comprise polar materials such as the EVA mentioned above or synthetic rubbers of the acrylonitrile-butadiene (NBR) type. The strong polarity of these materials, and thus their high adhesive power as regards many other polar materials, and even some metals, may cause unwanted adhesion phenomena between the semi-conductive layer intended to be peeled and the adjacent elements forming part of the construction of the cable such as, for example, the tapes surrounding said semi-conductive layer intended to prevent any water from possibly travelling along the cable in the event of perforation of the outer protective sheath. This type of unwanted adhesion complicates the preparation of the cable ends when the joints and/or terminals are fitted. In addition, during the production of the cable with a prior art semi-conductive layer intended to be peeled, the turns of the insulated conductors may be observed to stick together by means of the outer semi-conductive layer if the cooling at the outlet from the vulcanization tube is defective. Finally, adhesion between the polar semi-conductive layer obtained and a non-polar cross-linked polyethylene type layer (XLPE) is not optimized, so that the semi-conductive layer could become detached all by itself.

### Objects and Summary:

The aim of the present invention is to overcome the disadvantages of the prior art techniques by proposing an electrical cable, in particular a medium or high voltage cable, said cable comprising at least one semi-conductive layer with good peelability, in particular irrespective of whether the layer onto which said semi-conductive layer has been deposited is polar or non-polar in nature; a reduced tendency for spontaneous adhesion of said semi-conductive layer to the materials of adjacent elements and/or for spontaneous adhesion between elements adjacent to said semi-conductive layer; and an improved thermal stability.

A first object of the invention is to provide an electrical cable comprising at least one elongated electrically conducting element, an electrically insulating layer surrounding the elongated electrically conducting element, and a semi-conductive layer surrounding the electrically insulating layer, characterized in that the semi-conductive layer is a cross-linked layer obtained from a cross-linkable polymer composition comprising at least one non-polar olefin polymer, and at least approximately 15% by weight of a butene polymer, with respect to the total weight of the cross-linkable polymer composition.

By means of the combination of at least one non-polar olefin polymer and at least 15% by weight of a butene polymer, with respect to the total weight of the cross-linkable polymer composition, the semi-conductive layer of the cable of the invention obtained thereby has a good peelability, in particular, irrespective of whether the layer onto which said semi-conductive layer has been deposited is polar or non-polar in nature; a reduced tendency for spontaneous adhesion of said semi-conductive layer to the materials of adjacent elements and/or for spontaneous adhesion between the elements adjacent to said semi-conductive layer; and an improved thermal stability.

The Cross-Linkable Polymer Composition

The Butene Polymer

In the present invention, the butene polymer is a homopolymer or a copolymer of butene.

The cross-linkable polymer composition preferably comprises at least approximately 20% by weight, and particularly preferably at least approximately 25% by weight of butene polymer, with respect to the total weight of the cross-linkable polymer composition.

The cross-linkable polymer composition may comprise at most approximately 75% by weight, and preferably at most approximately 50% by weight of butene polymer, with respect to the total weight of the cross-linkable polymer composition.

The butene copolymer may be a copolymer of butene and an olefin selected from ethylene, propylene and C₅-C₁₂ olefins, preferably from ethylene, propylene and C₅-C₁₀ olefins, particularly preferably from ethylene, propylene and C₅-C₃ olefins, and more particularly preferably from ethylene.

According to a preferred embodiment, the butene copolymer comprises butene blocks and blocks of an olefin selected from ethylene, propylene and C₅-C₁₂ olefins, such that the proportion of butene blocks is majority.

In other words, when the copolymer of butene is a copolymer of butene and ethylene, it can respond to the following formula:

—(CH₂—CH₂)ₓ—(CH[CH₂—CH₃]—CH₂)_{y}—

in which y>1, x≤1 and y>x.

The olefin may be an alpha-olefin.

The butene copolymer may comprise at least approximately 30% by weight, preferably at least approximately 40% by weight, particularly preferably at least approximately 50% by weight, and more particularly preferably at least approximately 60% by weight of butene, with respect to the total weight of the butene copolymer.

The quantity of butene in the butene polymer may be readily determined using techniques which are well known to a person skilled in the art, in particular by NMR (nuclear magnetic resonance) spectroscopy and/or IR (infrared) spectroscopy.

The butene polymer in accordance with to the invention may have a molecular weight of at least approximately 10000 g/mol, preferably at least approximately 20000 g/mol, particularly preferably at least approximately 40000 g/mol, and more particularly preferably at least approximately 50000 g/mol.

The butene polymer in accordance with the invention is preferably in the solid form at ambient temperature, in particular at 18-25° C.

The butene polymer in accordance with the invention may have a melt flow index from approximately 0.4 to 1500 g/10 min, preferably from approximately 0.5 to 100 g/10 min, particularly preferably from approximately 1 to 50 g/10 min, and more particularly preferably from approximately 3 to 10 g/10 min, measured at approximately 190° C. under a load of approximately 2.16 kg in accordance with the ASTM standard D 1238-00.

The butene polymer in accordance with the invention may have an elastic modulus from approximately 20 to 1000 MPa, preferably from approximately 50 to 600 MPa, particularly preferably from approximately 100 to 600 MPa; and more particularly preferably from approximately 200 to 600 MPa.

The butene polymer in accordance with the invention is preferably obtained by Ziegler-Natty type polymerization.

In accordance with the invention, the term “Ziegler-Matta type polymerization” means a coordination polymerization obtained in the presence of a Ziegler-Natta catalyst, which may in particular be selected from halides of transition metals, in particular titanium, chromium, vanadium or zirconium, as a mixture with organic derivatives of metals other than transition metals, in particular an aluminium alkyl.

Typically, the butene polymer is obtained by starting from the polymerization of butene or the copolymerization of butene with a monomer that differs from butene, in the presence of a Ziegler-Matta catalyst, and preferably by polymerization or copolymerization in accordance with a low pressure process.

In accordance with a particularly preferred embodiment of the invention, the butene polymer is a homopolymer or a copolymer of 1-butene. In other words, the butene polymer is different from a polyisobutene.

The semi-conductive layer of the cable of the invention may advantageously be capable of functioning at temperatures of at least 100° C., while significantly limiting or even avoiding the deformation of the structure or the geometry of the cable, and thereby guaranteeing that it operates correctly in an operational configuration.

In accordance with a first variation, the butene polymer is a homopolymer of 1-butene.

In accordance with a second variation, the butene polymer is a copolymer of 1-butene.

In accordance with a preferred embodiment, the 1-butene copolymer is a copolymer of 1-butene and ethylene.

The butene polymer in accordance with the invention is preferably different from a butylene polymer.

The Conductive Filler

The cross-linkable polymer composition in particular comprises at least one conductive filler, in particular in a sufficient quantity to render the layer semi-conductive.

The cross-linkable polymer composition may comprise at least approximately 6% by weight of conductive filler, preferably at least approximately 10% by weight of conductive filler, more preferably at least approximately 15% by weight of conductive filler and yet more preferably at least approximately 25% by weight of conductive filler, with respect to the total weight of the cross-linkable polymer composition.

The cross-linkable polymer composition may comprise at most approximately 45% by weight of conductive filler, and preferably at most approximately 40% by weight of conductive filler, with respect to the total weight of the cross-linkable polymer composition.

The conductive filler is preferably an electrically conductive filler.

The conductive filler may advantageously be selected from carbon blacks, graphites, carbon nanotubes and a mixture thereof.

The Non-Polar Olefin Polymer

The non-polar olefin polymer is selected from homopolymers and copolymers of olefins selected from ethylene and C₃-C₁₂ olefins, preferably from ethylene and C₃-C₁₀ olefins, and particularly preferably from ethylene and C₃-C₈ olefins.

The olefin is preferably an alpha-olefin.

In accordance with one embodiment of the invention, the non-polar olefin polymer is selected from homopolymers and copolymers of ethylene.

In accordance with a preferred embodiment of the invention, the non-polar olefin polymer is selected from a linear very low density polyethylene, a linear low density polyethylene, a low density polyethylene, a copolymer of ethylene and octene, and a mixture thereof; and more particularly preferably selected from a linear very low density polyethylene, a linear low density polyethylene, a low density polyethylene and a mixture thereof.

In the present invention, the expression “low density” signifies a density from approximately 0.91 to 0.925, said density being measured in accordance with the ISO standard 1183A (at a temperature of 23° C.).

In the present invention, the expression “very low density” signifies a density from approximately 0.850 to 0.909, said density being measured in accordance with the ISO standard 1183A (at a temperature of 23° C.).

In accordance with one embodiment of the invention, the cross-linkable polymer composition comprises at least approximately 15% by weight, and preferably at least approximately 30% by weight, of non-polar olefin polymer, with respect to the total weight of the cross-linkable polymer composition.

In accordance with one embodiment of the invention, the cross-linkable polymer composition comprises at most approximately 75% by weight, and preferably at most approximately 50% by weight, of non-polar olefin polymer, with respect to the total weight of the cross-linkable polymer.

The cross-linkable polymer composition of the cable of the invention may comprise composition at least approximately 50% by weight, and preferably at least approximately 65% by weight of polymer(s), with respect to the total weight of the cross-linkable polymer composition.

In accordance with a preferred embodiment of the invention, the cross-linkable polymer comprises at least approximately 70% by weight, and more preferentially at least 80% by weight of non-polar polymer(s), with respect to the total weight of polymer(s) in the cross-linkable polymer composition. In this case, the number of % by weight of non-polar polymer(s) is expressed with respect to the total weight of polymer(s) in the cross-linkable polymer composition.

In the present invention, the expression “non-polar” signifies that the polymer of this type does not comprise polar functions such as, for example, acetate, acrylate, hydroxyl, nitrile, carboxyl, carbonyl, ether or ester groups, or any other groups with a polar nature which are well known in the prior art, such as notably silane groups. As an example, a non-polar polymer differs from a polymer selected from copolymers of ethylene of the copolymer of ethylene and vinyl acetate (EVA) type, the copolymer of ethylene and butyl acrylate (EBA) type, the copolymer of ethylene and ethyl acrylate (EEA) type, the copolymer of ethylene and methyl acrylate (EMA) type or the copolymer of ethylene and acrylic acid (EAA) type or the copolymer of ethylene and vinyl silane type.

The cross-linkable polymer composition of the cable of the invention may comprise at most approximately 30% by weight, preferably at most 20% by weight, and particularly preferably at most 10% by weight of polar polymer(s), with respect to the total weight of polymer(s) in the cross-linkable polymer composition. In this case, the number of % by weight of polar polymer(s) is expressed with respect to the total weight of polymer(s) in the cross-linkable polymer composition.

In the present invention, the expression “polar” signifies a polymer comprising polar functions, in particular acetate, acrylate, hydroxyl, nitrile, carboxyl, carbonyl, ether or ester groups, or any other groups with a polar nature which are well known in the prior art.

More particularly, the cross-linkable polymer composition may solely comprise the butene polymer and one or more non-polar olefin polymers as defined in the invention.

Furthermore, the semi-conductive layer has the advantage of being an easily peelable layer, in particular at ambient temperature (18-25° C.), and preferably with a peelability that is sustainable over time.

In the present invention, the semi-conductive layer of the invention is a layer that is said to be “peelable”, in particular in order to gain easy access to the subjacent layer or subjacent layers and/or to the elongated electrically conducting element. In this regard, the semi-conductive layer of the cable of the present invention may have a peelability force in the range of 4 to 45 Newton (N) (limits included), and preferably of 4 to 15 Newton, in accordance with the measurement method defined in the IEC standard 60502-2 (February 2014)

Accordingly, the semi-conductive layer of the invention has a sufficient adhesion to the subjacent layer or to the subjacent layers in order to prevent it from detaching all by itself; while having a peelability which is sufficient to facilitate removal, particularly manual removal, of at least a portion of this semi-conductive layer.

The semi-conductive layer of the invention has a very good thermal stability, in particular under an atmosphere of nitrogen.

More particularly, the semi-conductive layer of the cable of the invention has a weight loss of less than approximately 15%, preferably less than or equal to approximately 10%, and more particularly preferably less than or equal to approximately 5%, measured by thermogravimetric analysis (TGA) under an atmosphere of nitrogen at 350° C., and more particularly by heating at a rate of 10° C. per minute from 20° C. to 350° C., then by maintaining a temperature of 350° C. for 100 minutes. The weight loss of the semi-conductive layer is generally proportional to the degradability of the semi-conductive layer.

The semi-conductive layer of the invention also has a very smooth surface (i.e. with no roughness), good mechanical properties, in particular after thermal degradation, and it is easy to handle.

The Additives

The semi-conductive layer is a cross-linked layer. Thus, the cross-linked semi-conductive layer can have improved mechanical properties, and for this reason, the maximum operating temperature for the cable is increased.

In the present invention, the expression “cross-linked layer” signifies a layer with a gel content in accordance with the ASTM standard D2765-01 (extraction with xylene) which is at least approximately 40%, preferably at least approximately 50%, preferably at least approximately 60%, particularly preferably at least approximately 70%, and more particularly preferably at least approximately 80%.

The cross-linkable polymer composition may furthermore comprise at least one cross-linking agent.

The cross-linking agent may be selected from organic peroxides, silanes and/or any other cross-linking agent which is appropriate for cross-linking polyolefins.

Examples of organic peroxides which may be cited are peroxides of the tert-butylcumyl peroxide type or of the dicumyl peroxide, 2,5-dimethyl-2,5-di(tert-butylperoxy)hexyne-3 or 1,3 and 1,4-bis (tert-butylperoxyisopropyl)benzene type.

The cross-linkable polymer composition may typically comprise approximately 0.2% to 2.0% by weight, preferably approximately 0.5% to 1.0% by weight of cross-linking agent, with respect to the total weight of the cross-linkable polymer composition.

The cross-linkable polymer composition may furthermore comprise at least one antioxidant.

The antioxidants are preferably selected from hindered phenols, sulphur-based antioxidants, phosphorus-based antioxidants, amine type antioxidants, and a mixture thereof.

Examples of hindered phenols which may be cited are pentaerythritol tetrakis(3-(3,5-di-tert-butyl-4-hydroxyphenyl)propionate) (Irganox® 1010), octadecyl 3-(3,5-di-tert-butyl-4-hydroxyphenyl)propionate (Irganox® 1076), 1,3,5-trimethyl-2,4,6-tris(3,5-di-tert-butyl-4-hydroxybenzyl)benzene (Irganox® 1330), 4,6-bis(octylthiomethyl)-o-cresol (Irgastab® KV10 or Irganox® 1520), 2,2′-thio bis(6-tert-butyl-4-methylphenol) (Irganox® 1081), 2,2′-thiodiethylene bis[3-(3,5-di-tert-butyl-4-hydroxyphenyl) propionate] (Irganox® 1035), 2,2′-methylene bis(6-tert-butyl-4-methylphenol), 1,2-bis(3,5-di-tert-butyl-4-hydroxyhydrocinnamoyl) hydrazine (Irganox® MD 1024), tris(3,5-di-tert-butyl-4-hydroxybenzyl) isocyanurate (Irganox® 3114), or 2,2′-oxamido-bis(ethyl-3(3,5-di-tert-butyl-4-hydroxyphenyl)propionate).

Examples of sulphur-based antioxidants which may be cited are thioethers such as didodecyl-3,3′-thiodipropionate (Irganox® PS800), distearyl thiodipropionate or dioctadecyl-3,3′-thiodipropionate (Irganox® PS802), bis[2-methyl-4-{3-n-alkyl (C₁₂ or C₁₄) thiopropionyloxy}-5-tert-butylphenyl]sulphide, thiobis-[2-tert-butyl-5-methyl-4,1-phenylene] bis [3-(dodecylthio)propionate], or 4,6-bis(octylthiomethyl)-o-cresol (Irganox® 1520 or Irgastab® KV10).

Examples of phosphorus-based antioxidants which may be cited are phosphites or phosphonates, such as tris(2,4-di-tert-butyl-phenyl) phosphite (Irgafos® 168) or bis(2,4-di-tert-butylphenyl)pentaerythritol diphosphite (Ultranox® 626).

Examples of amine type antioxidants which may be cited are phenylene diamines (e.g. paraphenylene diamines such as 1PPD or 6PPD), diphenylamine styrenes, diphenylamines, 4-(1-methyl-1-phenylethyl)-N-[4-(1-methyl-1-phenylethyl)phenyl]aniline (Naugard 445), mercaptobenzimidazoles, or polymerized 2,2,4-trimethyl-1,2 dihydroquinoline (TMQ).

The cross-linkable polymer composition may typically comprise approximately 0.2% to 2% by weight, and preferably approximately 0.5% to 1.5% by weight of antioxidant, with respect to the total weight of the cross-linkable polymer composition.

The cross-linkable polymer composition may furthermore comprise one or more additives.

The additives are well known to a person skilled in the art and may be selected from processing aids such as lubricants, compatibilizing agents, coupling agents, water treeing inhibitors, pigments, non-conductive fillers, halogen-free mineral fillers intended to improve the fire behaviour of the semi-conductive layer, and a mixture thereof.

The cross-linkable polymer composition may typically comprise approximately 0.01% to 5% by weight, and preferably approximately 0.1% to 2% by weight of additive(s), with respect to the total weight of the cross-linkable polymer composition.

In the present invention, the term “semi-conductive layer” means a layer the electrical conductivity of which may be strictly higher than 1×10⁻⁸ S/m (Siemens per metre), preferably at least 1×10⁻³ S/m, and preferably may be less than 1×10³ S/m, measured at 25° C. under DC conditions.

The Electrically Insulating Layer

In the present invention, the term “electrically insulating layer” means a layer the electrical conductivity of which may be at most 1×10⁻⁸ S/m (Siemens per metre), preferably at most 1×10⁻⁹ S/m, and particularly preferably at most 1×10⁻¹⁰ S/m (Siemens per metre), measured at 25° C. under DC conditions.

More particularly, the semi-conductive layer has an electrical conductivity which is higher than that of the electrically insulating layer. More particularly, the electrical conductivity of the electrically insulating layer may be at least 10 times less than the electrical conductivity of the semi-conductive layer, preferably at least 100 times less than the electrical conductivity of the semi-conductive layer, and particularly preferably at least 1000 times less than the electrical conductivity of the semi-conductive layer.

The electrically insulating layer may comprise at least one olefin polymer, which may be polar or non-polar.

More particularly, the electrically insulating layer comprises at least one polymer selected from ethylene polymers, propylene polymers, and a mixture thereof, and preferably from ethylene polymers.

Examples of ethylene polymers which may be cited are a linear low density polyethylene (LLDPE), a low density polyethylene (LDPE), a very low density polyethylene (VLDPE), a medium density polyethylene (MDPE), a high density polyethylene (HDPE), copolymers of ethylene and vinyl acetate (EVA), copolymers of ethylene and of butyl acrylate (EBA), of methyl acrylate (EMA), of 2-hexylethyl acrylate (2HEA), copolymers of ethylene and alpha-olefins such as, for example, polyethylene-octenes (PEO), copolymers of ethylene and propylene (EPR), ethylene/ethyl acrylate copolymers (EEA), or terpolymers of ethylene and propylene (EPT) such as, for example, terpolymers of ethylene propylene diene monomer (EPDM), or a mixture thereof.

In the present invention, the expression “medium density” signifies a density of approximately 0.926 to 0.940, said density being measured in accordance with the ISO standard 1183A (at a temperature of 23° C.).

In the present invention, the expression “high density” signifies a density of approximately 0.941 to 0.965, said density being measured in accordance with the ISO standard 1183A (at a temperature of 23° C.).

In accordance with a particularly preferred embodiment of the invention, the electrically insulating layer is a cross-linked layer.

In particular, the electrically insulating layer comprises at least one cross-linked polymer of ethylene (XLPE).

The Cable

The elongated electrically conducting element of the invention may be of the single-stranded or multi-stranded type. Preferably, said elongated electrically conducting element is formed from copper, a copper alloy, aluminium or an aluminium alloy.

The electrical cable of the invention may furthermore comprise a further semi-conductive layer surrounding said elongated electrically conducting element, which is in turn surrounded by the electrically insulating layer.

Thus, in this embodiment, the cable of the invention may comprise at least one elongated electrically conducting element, in particular positioned in the centre of the cable:
surrounded by a first semi-conductive layer, or in other words surrounded by said further semi-conductive layer of the invention,
the first semi-conductive layer being surrounded by an electrically insulating layer, or in other words surrounded by said electrically insulating layer of the invention, and
the electrically insulating layer being surrounded by a second semi-conductive layer, the second semi-conductive layer in this embodiment being the semi-conductive layer as described in the present invention.

Thus, the first semi-conductive layer, the electrically insulating layer and the second semi-conductive layer constitute a triple layer of insulation. More particularly, the first semi-conductive layer is in direct physical contact with the electrically insulating layer, and the second semi-conductive layer is in direct physical contact with the electrically insulating layer.

The semi-conductive layer of the cable of the invention is preferably an extruded layer, in particular employing techniques which are well known to a person skilled in the art.

The electrical cable of the invention may furthermore comprise a metallic screen surrounding the semi-conductive layer of the cable of the invention, the semi-conductive layer of the cable of the invention being that which surrounds the electrically insulating layer.

This metallic screen may be what is known as a “wire” screen composed of an assembly of copper or aluminium conductors arranged around and along the semi-conductive layer, a screen known as a “tape” screen composed of one or more conducting metallic tapes helically wound around the semi-conductive layer, or a screen known as a “sealed” screen of the metal tube type which surrounds the semi-conductive layer. This latter type of screen can in particular act as a barrier to moisture which has a tendency to penetrate into the electrical cable in the radial direction.

Any of the types of metallic screen may act to earth the electrical cable and may thus transport fault currents, for example in the case of a short-circuit in the network concerned.

Furthermore, the electrical cable of the invention may comprise an outer protective sheath surrounding the second semi-conductive layer, or in fact more particularly surrounding said metallic screen if it is present. This outer protective sheath may be produced in a conventional manner from appropriate thermoplastic materials such as HDPEs, MDPEs or LLDPEs; or even from flame retardant materials or flame resistant materials. In particular, if these latter materials do not contain any halogens, this is known as an HFFR (“halogen free flame retardant”) type sheathing.

Other layers such as layers which expand in the presence of moisture, may be added between the second semi-conductive layer and the metallic screen if it is present, and/or between the metallic screen and the outer sheath if they are present, these layers ensuring that the length of the cable is impermeable to water. The electrical conductor of the cable of the invention may also comprise materials which expand in the presence of moisture in order to obtain a “sealed core”.

In order to guarantee that an electrical cable is an “HFFR” (halogen free flame retardant), the cable of the invention preferably does not contain halogenated compounds. These halogenated compounds may be of any nature such as, for example, fluorinated polymers or chlorinated polymers such as polyvinyl chloride (PVC), halogenated plasticizers, halogenated mineral fillers, etc.

The cross-linked semi-conductive layer of the cable of the invention may comprise at least one non-polar olefin polymer and at least approximately 15% by weight of a butene polymer, with respect to the total weight of the semi-conductive layer.

The cross-linked semi-conductive layer may further comprise a conductive filler.

The cross-linked semi-conductive layer may further comprise an antioxidant, and optionally one or more additives.

The non-polar olefin polymer, the butene polymer, the conductive filler, the antioxidant and the additives are as defined in the invention.

The proportions of the various ingredients in the cross-linked semi-conductive layer may be identical to those as described in the invention for these same ingredients in the cross-linkable polymer composition.

The electrical cable may be prepared by extrusion of the cross-linkable polymer composition around said elongated electrically conducting element, and more particularly around the electrically insulating layer, in order to obtain an extruded semi-conductive layer, and by cross-linking the extruded semi-conductive layer.

The extrusion may be carried out using techniques which are well known to a person skilled in the art, with the aid of an extruder.

During the extrusion, the cross-linkable polymer composition leaving the extruder is said to be “not cross-linked”, the temperature as well as the processing time within the extruder being optimized as a consequence.

At the outlet from the extruder, therefore, a semi-conductive layer is obtained which has been extruded around said electrically conducting element, and more particularly around the electrically insulating layer.

Prior to or concomitantly with the extrusion of the cross-linkable polymer composition in order to form the semi-conductive layer, the electrically insulating layer of the electrical cable of the invention may be obtained by extrusion. The electrically insulating and semi-conductive layers may thus be obtained by successive extrusion or by co-extrusion.

Prior to extrusion of these layers around said elongated electrically conducting element, the assembly of the polymer constituents necessary for the formation of these layers may be metered and mixed in a continuous mixer of the BUSS co-kneader type, twin screw extruder type or another type of mixer which is appropriate for polymer blends, in particular filled blends. The resulting mixture may then be extruded in the form of rods, then cooled and dried so that they can be formed into granules or then the mixture may be directly formed into granules using techniques which are well known to a person skilled in the art. These granules may then be impregnated with one or more additives as defined in the invention, as well as with the cross-linking agent, then dried, and introduced into a single screw extruder in order to extrude the layer in question.

The various compositions may be extruded one after the other in order to successively surround the elongated electrically conducting element, and thus to form the various layers of the electrical cable of the invention.

Alternatively, they may be extruded concomitantly by co-extrusion with the aid of a single extruder head; co-extrusion is a process which is well known to a person skilled in the art.

Irrespective of whether it is in the granule formation step or in the step for extrusion onto cable, the operating conditions are well known to a person skilled in the art. In particular, the temperature inside the mixing device or the extrusion device may be higher than the fusion temperature of the major polymer or of the polymer with the highest fusion temperature among the polymers utilized in the composition to be used.

Typically, once the cross-linkable polymer composition of the invention has been positioned around the elongated electrically conducting element, and more particularly around the electrically insulating layer, by extrusion, the cross-linking may be carried out using a thermal pathway, for example with the aid of a continuous vulcanization line (“CV line”), a steam tube, a molten salt bath, a furnace or a thermal chamber, these techniques being well known to a person skilled in the art.

Cross-linking in a steam tube or a nitrogen tube for vulcanization at a temperature which may be in the range of approximately 250° C. to 400° C. is preferred.

The cross-linkable polymer composition may be cross-linked using techniques which are well known to a person skilled in the art, such as peroxide cross-linking, silane cross-linking, or irradiation cross-linking, in particular using an electron beam (beta radiation).

### BRIEF DESCRIPTIONS OF THE DRAWINGS

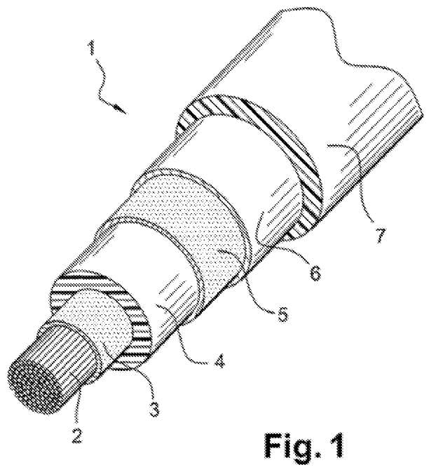

Other characteristics and advantages of the present invention will become apparent in light of the description of a non-limiting example of an electrical cable in accordance with the invention, made with reference to FIG. 1 which shows a diagrammatic perspective sectional view of an electrical cable according to a preferred embodiment in accordance with the invention.

For the purposes of clarity, only the elements which are essential to comprehension of the invention are shown in a diagrammatic manner, and not to scale.

### DETAILED DESCRIPTION

The cable is a medium or high voltage power cable 1, illustrated in FIG. 1, and it comprises a central elongated electrically conducting element 2, in particular formed from copper or aluminium and, successively and coaxially around this element 2, it comprises a first semi-conductive layer 3 termed the “inner semi-conductive layer”, an electrically insulating layer 4, a second semi-conductive layer 5 termed the “outer semi-conductive layer”, a metallic screen 6 of the cylindrical tube type, and an outer protective sheath 7.

The outer semi-conductive layer 5 of FIG. 1 is a semi-conductive layer in accordance with the invention.

In the cable of FIG. 1, the layers 3, 4 and 5 are typically extruded polymeric layers.

The presence of the metallic screen 6 and the outer protective sheath 7 is preferred, but is not essential; this type of structure of a cable per se is well known to a person skilled in the art.

### Example

### 1. Preparation of Semi-Conductive Layers

In order to demonstrate the properties of the invention, a semi-conductive layer was produced from a cross-linkable polymer composition in accordance with the invention, i.e. comprising at least one non-polar olefin polymer, and at least 15% by weight of a butene polymer, and was compared with a semi-conductive layer produced from a comparative cross-linkable polymer composition C1 of the prior art comprising no butene polymer.

Table 1 below brings together the cross-linkable polymer compositions I1 and C1, wherein the quantities of the compounds are expressed as percentages by weight with respect to the total weight of the composition.

TABLE 1

| Composition | C1 (*) | I1 |
|---|---|---|
| Non-polar olefin polymer | 0.0 | 42.6 |
| Butene polymer | 0.0 | 25.5 |
| EVA | 36.0 | 0.0 |
| NBR | 17.9 | 0.0 |
| Polyethylene wax | 3.8 | 0.0 |
| Chalk | 6.0 | 0.0 |
| Stearyl erucamide | 0.9 | 0.0 |
| Antioxidant | 1.0 | 1.5 |
| Conductive filler | 33.8 | 29.8 |
| Organic peroxide | 0.6 | 0.6 |
| Total ingredients in composition | 100 | 100 |

(*) Comparative composition not forming part of the invention

The origins of the compounds of Table 1 were as follows:
non-polar olefin polymer: linear low density polyethylene sold by Versalis with the reference Clearflex FGH B0;
butene polymer: butene homopolymer sold by Lyondellbasell with the reference PB 0300M;
EVA: copolymer of ethylene and vinyl acetate sold by Exxon Mobil Chemicals with the reference Escorene Ultra UL00728;
NBR: nitrile rubber sold by Arlanxeo with the reference Baymod N 34.82;
polyethylene wax sold by Clariant with the reference Licowax PE 520;
chalk sold by Omya with the reference Omcarb EXH-1 SP;
stearyl erucamide sold by PMC with the reference Biogenix Kemamide E-180;
antioxidant: polymerized 2,2,4-trimethyl-1,2 dihydroquinoline (TMQ) sold by Lanxess with the reference Vulkanox HS/LG “Low Salt”;
conductive filler: carbon black sold by Orion with the reference Printex MV (composition I1) or by Birla with the reference Conductex 7095 Ultra (composition C1); and
organic peroxide: tert-butyl cumyl peroxide sold by NOURYON with the reference Trigonox T.

With the exception of the liquid organic peroxide, all of the constituents of the various compositions of Table 1 could be mixed in a continuous mixture of the BUSS co-kneader type, twin screw extruder type or another type of mixer which is appropriate for rubber blends or filled thermoplastic blends.

As is conventional, the polymer materials were fused in the continuous mixer, the other constituents of the mixture were introduced and dispersed in the fused polymeric matrix, and the mixture was homogenized.

The mixture was then extruded in the form of rods. The rods were then cooled and dried in order to be formed into granules. These granules were then impregnated with liquid organic peroxide.

The process for the impregnation of the granules means that in particular, the peroxide is added after forming the granules, thereby preventing the peroxide from starting to cross-link the fused polymeric matrix and forming a polymer gel (a phenomenon which is known as “scorching”). In particular, the peroxide is preferably introduced into a phase in the process where the temperatures are not too high.

These impregnated granules were placed in suitable moulds in order to be able to form cross-linked sheets by compression and by heat treatment. In order to form these circular cross-linked sheets, a DK 60 automatic heating press was used under the conditions shown in Table 2 below, steps 1 to 4 being carried out successively.

Typically, a moulding cycle comprised the following steps:
the granules were placed in the mould provided with non-stick Teflon films,
the mould was closed by its cover and was placed on the press, pre-heated to 60° C., in order to bring it up to temperature,
when the mould was at 60° C., the press was placed under pressure,
the mould was heated to 130° C. in order to allow cross-linking,
the mould was cooled and the cross-linked sheets were unmoulded.

TABLE 2

| Steps | Step 1 | Step 2 | Step 3 | Step 4 |
|---|---|---|---|---|
| Temperature of | 130 | 130 | 130 | 50 |
| press (° C.) | | | | |
| Pressure of | 6 | 12 | 12 | 12 |
| press (bar) | | | | |
| Duration | 4 | 1 | 0.5 | 4 |
| (minutes) | | | | |

Once step 4 had been carried out, the circular sheet was unmoulded then cooled to ambient temperature. It had a thickness of between 0.5 and 1.5 mm.

### 2. Preparation of Electrically Insulating Layers

Two electrically insulating compositions termed “reference”, 12 and 13, were prepared using a process like that described above with a continuous mixer, then the granules were formed using techniques which are well known to a person skilled in the art.

The composition 12 comprised 98.23% by weight of a low density polyethylene sold by INEOS with the reference BPD 2000, 0.22% by weight of 4,6-bis(octylthiomethyl)-o-cresol sold by BASF with the reference Irgastab KV 10 as the antioxidant, and 1.55% by weight of tert-butyl cumyl peroxide sold by NOURYON with the reference Trigonox T as the organic peroxide, with respect to the total weight of the composition.

The composition 13 was a composition sold by Borealis with the reference Borlink LH4201R, comprising a low density polyethylene and a copolymer of ethylene and a polar co-monomer.

These granules were then pressed in order to form circular sheets with the aid of a DK60 heating press under the conditions brought together in Table 3 below, steps 1 to 4 being carried out successively:

TABLE 3

| Steps | Step 1 | Step 2 | Step 3 | Step 4 |
|---|---|---|---|---|
| Temperature of | 130 | 130 | 130 | 50 |
| press (° C.) | | | | |
| Pressure of | 3 | 12 | 12 | 12 |
| press (bar) | | | | |
| Duration | 4 | 1 | 0.5 | 4 |
| (minutes) | | | | |

Once step 4 had been carried out, the circular sheet was unmoulded then cooled to ambient temperature. It had a thickness of between 0.5 and 1.5 mm.

### 3. Preparation of Double Layers

A first circular sheet of electrically insulating layer and a second circular sheet of semi-conductive layer obtained as above were positioned on top of each other in order to form a double layer and placed in a DK 60 heating press under the conditions brought together in Table 4 below; steps 1 to 3 being carried out successively:

TABLE 4

| Steps | Step 1 | Step 2 | Step 3 |
|---|---|---|---|
| Temperature of | 190 | 190 | 50 |
| press (° C.) | | | |
| Pressure of | 2 | 3 | 3 |
| press (bar) | | | |
| Duration | 5 | 2 | 4 |
| (minutes) | | | |

During the preparation of the double layer, before placing it in the press, a polyester film was positioned between a portion of the two layers in order to be able to carry out the peelability test subsequently by easily separating the portion of the two layers separated by said film.

Once step 3 had been carried out, the double layer was unmoulded then cooled to ambient temperature. It had a thickness or between 1 and 3 mm.

The peelability test was carried out with the aid of an Alpha Technologies T2000 tensile testing machine, comprising the following steps:
rectangles of 200 mm by 10 mm were cut out from the circular double layer,
approximately 25 mm in length of the semi-conductive layer out of the 200 mm of the double layer was separated from the electrically insulating layer because of the polyester film which had been positioned in a portion of the double layer beforehand in order to obtain separation of the double layer in this portion,
the end of the separated portion of the semi-conductive layer was fixed to a stationary gripping means of the tensile testing machine, while the end of the portion of the separated electrically insulating layer was fixed to a movable gripping means of the tensile testing machine, and
the force necessary to separate the semi-conductive layer from the electrically insulating layer was measured over a separation distance of at least 100 mm with an angle of 180° and a tensile speed of 250±50 mm/min.

Five specimens were tested per double layer formed.

The peelability results (in Newton) are brought together in Table 5 below.

TABLE 5

| | Double | Double | Double | Double |
|---|---|---|---|---|
| | layer | layer | layer | layer |
| | c1/i2 (*) | c1/i3 (*) | i1/i2 | i1/i3 |
| Peelability | 5.79 | 19.13 | 7.87 | 4.27 |
| (N) | | | | |

(*) Comparative double layers which do not form part of the invention

This set of results shows that the semi-conductive layer of the cable of the invention has very good peelability, irrespective of whether the nature of the subjacent electrically insulating layer is polar or non-polar; this is in contrast to that of the prior art.

1. Electrical cable comprising:
at least one elongated electrically conducting element;
an electrically insulating layer surrounding the elongated electrically conducting element; and
a semi-conductive layer surrounding the electrically insulating layer,
wherein the semi-conductive layer is a cross-linked layer obtained from a cross-linkable polymer composition comprising at least one non-polar olefin polymer and at least 15% by weight of a butene polymer, with respect to the total weight of the cross-linkable polymer composition.

2. Electrical cable according to claim 1, wherein the butene polymer is a copolymer of 1-butene.

3. Electrical cable according to claim 1, wherein the butene polymer is a copolymer of 1-butene and an olefin selected from ethylene, propylene and C₅-C₁₂ olefins.

4. Electrical cable according to claim 1, wherein the butene polymer is a homopolymer of 1-butene.

5. Electrical cable according to claim 1, wherein the butene polymer has a molecular weight of at least 10000 g/mol.

6. Electrical cable according to claim 1, wherein the cross-linkable polymer composition comprises at least 6% by weight of a conductive filler, with respect to the total weight of the cross-linkable polymer composition.

7. Electrical cable according to claim 1, wherein the non-polar olefin polymer is selected from homopolymers and copolymers of ethylene.

8. Electrical cable according to claim 1, wherein the non-polar olefin polymer is selected from a linear very low density polyethylene, a linear low density polyethylene, a low density polyethylene, a copolymer of ethylene and octene, and a blend thereof.

9. Electrical cable according to claim 1, wherein the cross-linkable polymer composition comprises at least 20% by weight of butene polymer, with respect to the total weight of the cross-linkable polymer composition.

10. Electrical cable according to claim 1, wherein the cross-linkable polymer composition comprises at least 15% by weight of non-polar olefin polymer, with respect to the total weight of the cross-linkable polymer composition.

11. Electrical cable according to claim 1, wherein the cross-linkable polymer composition comprises at least 50% by weight of polymer(s), with respect to the total weight of the cross-linkable polymer composition.

12. Electrical cable according to claim 1, wherein the cross-linkable polymer composition comprises at most 30% by weight of polar polymer(s), with respect to the total weight of polymer(s) in the cross-linkable polymer composition.

13. Electrical cable according to claim 1, wherein the cross-linkable polymer composition further comprises at least one cross-linking agent.

14. Electrical cable according to claim 1, wherein the cross-linkable polymer composition further comprises at least one antioxidant.

15. Electrical cable according to claim 1, wherein the electrically insulating layer comprises at least one olefin polymer.

16. Electrical cable according to claim 1, wherein said electrical cable additionally comprises a further semi-conductive layer surrounding the elongated electrically conducting element which is in turn surrounded by the electrically insulating layer.
